(19) United States
(12) Patent Application Publication
(10) Pub. No.: US 2012/0120456 A1
(43) Pub. Date: May 17, 2012

(54) IMAGE PROCESSING APPARATUS, IMAGE PROCESSING SYSTEM, AND COMPUTER READABLE MEDIUM

(75) Inventor: Yuichi SHIHO, Kanagawa (JP)

(73) Assignee: FUJI XEROX CO., LTD., Tokyo (JP)

(21) Appl. No.: 13/117,633

(22) Filed: May 27, 2011

(30) Foreign Application Priority Data
Nov. 15, 2010 (JP) 2010-254820

(51) Int. Cl. H04N 1/40

(52) U.S. Cl. 358/448

(57) ABSTRACT

An image processing apparatus includes a receiving unit and a first difference extracting unit. The receiving unit receives images of a document. The first difference extracting unit performs difference extracting processing for extracting a difference between images of a document having 2n (n=2, 3, . . . ) pages received by the receiving unit by comparing the image of the first page and the image of the (n+1)-th page, the image of the second page and the image of the (n+2)-th page, the image of the third page and the image of the (n+3)-th page, . . . , and the image of the n-th page and the image of the 2n-th page.

### CROSS-REFERENCE TO RELATED APPLICATIONS

This application is based on and claims priority under 35 USC 119 from Japanese Patent Application No. 2010-254820 filed Nov. 15, 2010.

### BACKGROUND

### (i) Technical Field

The present invention relates to image processing apparatuses, image processing systems, and computer readable media.

### SUMMARY

According to an aspect of the invention, there is provided an image processing apparatus including: a receiving unit that receives images of a document; and a first difference extracting unit that performs difference extracting processing for extracting a difference between images of a document having 2n (n=2, 3, . . . ) pages received by the receiving unit by comparing the image of the first page and the image of the (n+1)-th page, the image of the second page and the image of the (n+2)-th page, the image of the third page and the image of the (n+3)-th page, . . . , and the image of the n-th page and the image of the 2n-th page.

### BRIEF DESCRIPTION OF THE DRAWINGS

Exemplary embodiment(s) of the present invention will be described in detail based on the following figures, wherein:

FIG. 1 is a block diagram schematically illustrating the configuration of an image forming apparatus according to an exemplary embodiment of the invention;

FIG. 2 is a sectional view illustrating the schematic configuration of an image reader;

FIG. 3 is a plan view illustrating the schematic configuration of a document supply unit;

FIG. 4 is a plan view illustrating the arrangement of document detection sensors provided for a scanner;

FIG. 5 illustrates difference extracting processing;

FIGS. 6A and 6B illustrate documents to be compared;

FIG. 7 is a flowchart illustrating processing for starting difference extracting processing;

FIG. 8 is a flowchart illustrating the overall difference extracting processing;

FIG. 9 is a flowchart illustrating parameter setting processing;

FIG. 10 is a flowchart illustrating image reading processing;

FIG. 11 illustrates an example of a parameter setting screen;

FIG. 12 illustrates an example of a parameter setting screen when the parameter of the document reading order is set to “units of sets of documents”;

FIG. 13 illustrates an example of a parameter setting screen after parameter setting restriction processing has been performed;

FIG. 14 is a flowchart illustrating difference extracting processing;

FIG. 15 is a flowchart illustrating automatic inversion adjustment processing; and

FIG. 16 illustrates an example of a menu screen for presetting an operation when it is difficult to continue processing.

### DETAILED DESCRIPTION

An image forming apparatus according to an exemplary embodiment of the invention is described below.

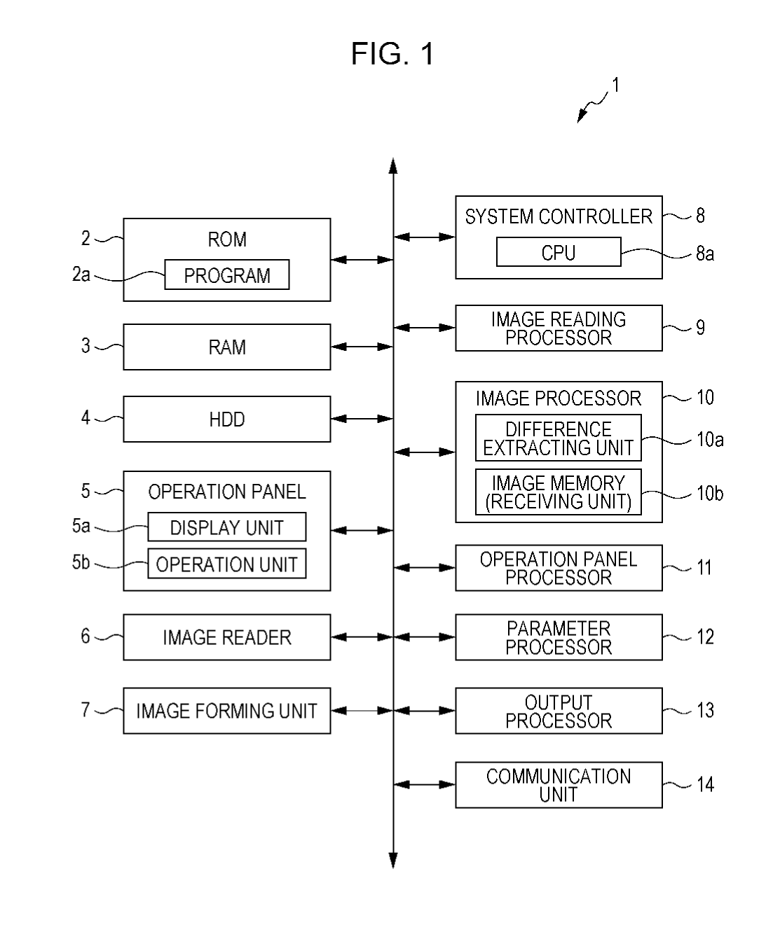

FIG. 1 is a block diagram schematically illustrating the configuration of an image forming apparatus 1 according to this exemplary embodiment of the invention.

The image forming apparatus 1 includes, as shown in FIG. 1, a read only memory (ROM) (including a non-volatile memory) 2, a random access memory (RAM) 3, a hard disk drive (HDD) 4, an operation panel 5, an image reader 6, an image forming unit 7, a system controller 8, an image reading processor 9, an image processor 10, an operation panel processor 11, a parameter processor 12, an output processor 13, and a communication unit 14.

The operation panel 5 includes a display unit (display screen) 5a that displays information which is given to a user and an operation unit 5b from which a user inputs instructions by operating the operation unit 5b. The display unit 5a and the operation unit 5b are integrally formed.

The operation panel processor 11 performs processing concerning the operation panel 5. That is, the operation panel processor 11 displays a menu screen on the display unit 5a of the operation panel 5 and outputs instructions input by a user by operating the operation unit 5b to an element that requires the instructions, such as the parameter processor 12.

In the ROM 2, the RAM 3, and the HDD 4, data and information necessary for performing various processing are stored. For example, in the ROM 2, a program 2a and data used by various controllers and processors are stored.

The program 2a may be stored in the ROM 2 at the time of shipping of the image forming apparatus 1. Alternatively, the program 2a may be stored in the ROM 2 by being read from a storage medium, such as a compact disc (CD)-ROM, by a user after shipping the image forming apparatus 1.

The system controller 8 controls the overall system under the control of the computation of a central processing unit (CPU) 8a. For example, the system controller 8 performs arbitration, as the core of the system, among various processing requests, such as print requests and copy requests, so as to operate to effectively utilize the resources of the system. The system controller 8 also controls the image reading processor 9 and the image processor 10 so as to perform predetermined processing.

In response to copy requests, the image forming unit 7 forms images on the basis of image data read by using the reader 6. The image forming unit 7 forms images on a recording medium, such as paper, according to an electrophotographic system, an ink-jet system, or another printing system.

The communication unit 14 is used for allowing the image forming apparatus 1 to communicate with external devices. For example, the communication unit 14 performs facsimile communication or sends and receives e-mail by using a communication medium, such as a local area network (LAN), the Internet, or a public switched network.

The image reader 6 is configured to optically read images on a document.

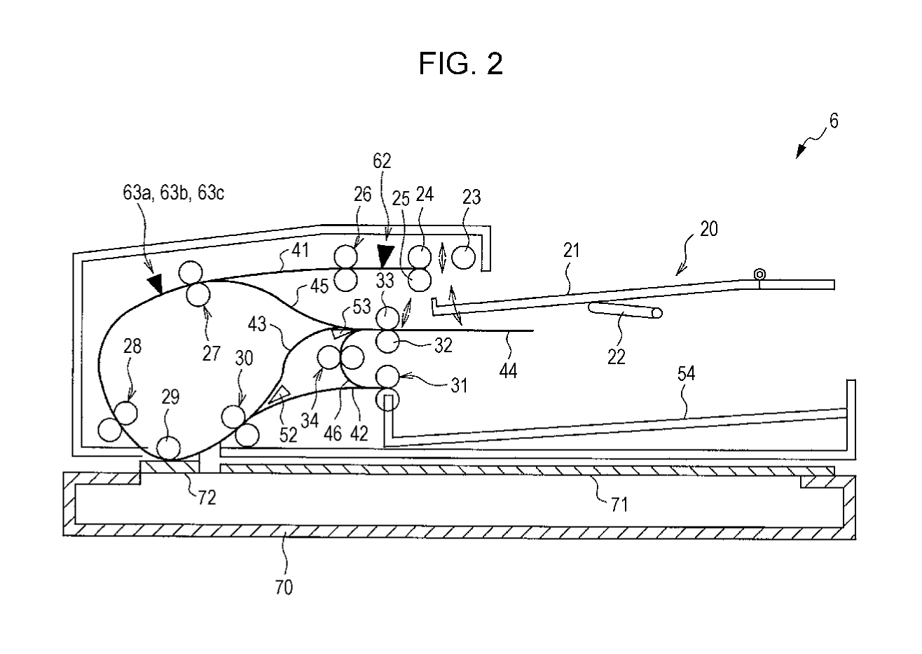

FIG. 2 schematically illustrates the configuration of the image reader 6. The image reader 6 includes, as shown in FIG. 2, a document feeder 20 and a scanner 70. Provided with the document feeder 20, the image reader 6 implements a scan system by having an auto document feeder (ADF).

The document feeder 20 includes a document supply unit 21, a lift support 22, a feed roller (pickup roller) 23, a supply roller 24, and a retard roller 25. These elements form a transport portion of the document feeder 20 for sequentially transporting documents placed on the document supply unit 21.

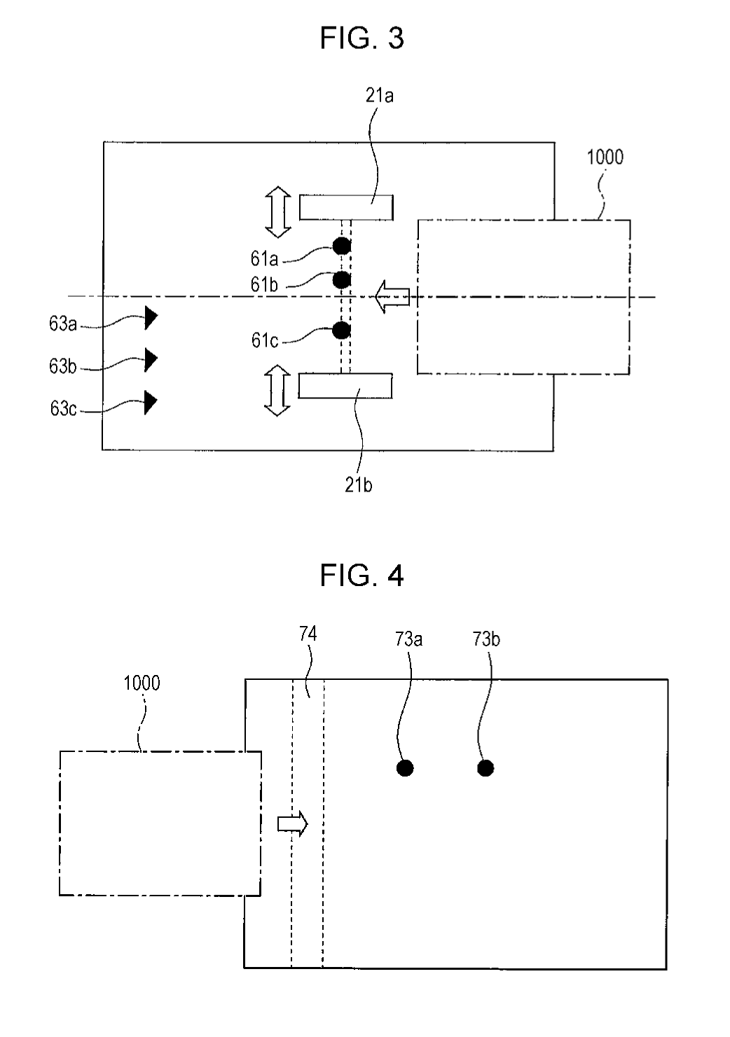

FIG. 3 is a plan view illustrating the schematic configuration of the document supply unit 21.

On the top surface of the document supply unit 21, as shown in FIG. 3, first and second guide members 21a and 21b for guiding two edges (in the widthwise direction) of a document 1000 are provided. The first and second guide members 21a and 21b are disposed such that they can be separated from each other.

The document supply unit 21 also includes guide member movement sensors 61a, 61b, and 61c, which serve as document size detectors. The guide member movement sensors 61a, 61b, and 61c are moved in cooperation with the movements of the first and second guide members 21a and 21b so as to detect the movements of the first and second guide members 21a and 21b. The guide member movement sensors 61a, 61b, and 61c output detection signals to the image reading processor 9.

Referring back to the description of the image reader 6 shown in FIG. 2, the feed roller 23 feeds documents placed on the document supply unit 21 to a first transport path 41 provided within the document feeder 20. The supply roller 24 transports the documents fed by the feed roller 23 farther downstream. The retard roller 25 separates the documents fed by the feed roller 23 one by one.

The document feeder 20 includes, within the first transport path 41 to which documents are first transported, a take-away roller 26, a pre-registration roller 27, a registration roller 28, a platen roller 29, and an out roller 30. The take-away roller 26 is disposed on the downstream side of the retard roller 25 and transports the documents that are separated one by one by the retard roller 25 to the pre-registration roller 27 disposed farther downstream than the take-away roller 26. The pre-registration roller 27 transports the documents transported by the take-away roller 26 to the registration roller 28 disposed farther downstream than the registration roller 27. The registration roller 28 is rotated in accordance with a time at which the reading of a document is started, and supplies a document to the platen roller 29 (scanner 70) while performing registration adjustments.

The platen roller 29 presses a document supplied from the registration roller 28 against a second contact glass plate 72, which is discussed later, of the scanner 70, and assists the transportation of a document which is being read. The out roller 30 transports a document which has been read farther downstream.

The document feeder 20 also includes transport document detection sensors 62, 63a, 63b, and 63c, which serve as document size detectors, in the first transport path 41. The transport document detection sensor 62 is disposed after the supply roller 24. The transport document detection sensors 63a, 63b, and 63c are disposed between the pre-registration roller 27 and the registration roller 28. The transport document detection sensors 63a, 63b, and 63c are disposed side by side in the widthwise direction (main scanning direction) of a document which is transported. The transport document detection sensors 63a, 63b, and 63c output detection signals to the image reading processor 9.

In the document feeder 20, second and third transport paths 42 and 43 are disposed on the downstream side of the out roller 30. The document feeder 20 also includes a switching gate 52 and a first discharge roller 31 on the downstream side of the out roller 30.

The switching gate 52 switches between the second and third transport paths 42 and 43 so as to switch the transport direction of a document. More specifically, the switching gate 52 switches the transport direction so as to guide a document supplied from the out roller 30 to the second transport path 42 when reading of a single-sided page document is completed or when reading of both sides of a double-sided page document is completed. On the other hand, when reversing the side of a double-sided page document on which reading of one side has been finished, the switching gate 52 switches the transport direction so as to guide the double-sided page document to the third transport path 43.

The first discharge roller 31 discharges a document supplied from the out roller 30 to a discharge unit 54 when reading of a single-sided page document is completed or when reading of both sides of a double-sided page document is completed.

The document feeder 20 also includes fourth and fifth transport paths 44 and 45. The fourth and fifth transport paths 44 and 45, and the above-described third transport path 43 are all used for reversing the side of a document. Accordingly, the third and fourth transport paths 43 and 44 are connected, and the fourth and fifth transport paths 44 and 45 are connected. Further, the fifth and first transport paths 45 and 41 are connected.

The document feeder 20 includes an inverter roller 32 and an inverter pinch roller 33 in the fourth transport path 44. The inverter roller 32 and the inverter pinch roller 33 switch back a document which has been transported through the third transport path 43. More specifically, in the inverter pinch roller 33, a feed clutch (not shown) is in the OFF state at the retreat position so as to cause the nip to be open, thereby guiding a document which has been transported through the third transport path 43 to the fourth transport path 44. Thereafter, the inverter pinch roller 33 is nipped, and the inverter roller 32 guides the document to the pre-registration roller 27 disposed in the first transport path 41 via the fifth transport path 45.

The document feeder 20 also includes a sixth transport path 46. The sixth transport path 46 is used for discharging a document which has been transported from the third transport path 43 to the fourth transport path 44 to the discharge unit 54. The document feeder 20 includes a switching gate 53 and a second discharge roller 34 in the sixth transport path 46.

The switching gate 53 switches between the fifth and sixth transport paths 45 and 46 so as to switch the transport direction of a document. More specifically, when reversing and discharging a document, the switching gate 53 is switched to guide the document transported by the inverter pinch roller 33 to the sixth transport path 46. The second discharge roller 34 transports the document which has been transported to the sixth transport path 46 to the first discharge roller 31. The first discharge roller 31 discharges the document supplied from the inverter pinch roller 33 to the discharge unit 54.

With the above-described configuration of the image reader 6, when reading an image on a single-sided page document, the document placed on the document supply unit 21 is fed into the document feeder 20 by the feed roller 23, and is then transported through the first transport path 41 by the supply roller 24, the take-away roller 26, the pre-registration roller 27, and the registration roller 28. Then, when the document passes through the second contact glass plate 72, which is discussed later, of the scanner 70, it is pressed against the second contact glass plate 72 by the platen roller 29, and is transported to the out roller 30. Then, the document is guided to the second transport path 42 by the out roller 30, and is discharged to the discharge unit 54 by the first discharge roller 31.

When reading a double-sided page document, in a manner similar to the reading of a single-sided page document, after reading one side of the document, the document is transported through the third transport path 43 by the out roller 30 and is guided to the fourth transport path 44. Then, the document is switched back by the inverter roller 32 and the inverter pinch roller 33 provided in the fourth transport path 44 and is guided to the pre-registration roller 27 provided in the first transport path 41. Thereafter, the document is again transported through the first transport path 41 by the pre-registration roller 27 and the registration roller 28. Then, when passing on the second contact glass plate 72 of the scanner 70, the document is pressed against the second contact glass plate 72 by the platen roller 29, and is transported to the out roller 30. Thereafter, the document is guided to the second transport path 42 by the out roller 30, and is discharged to the discharge unit 54 by the first discharge roller 31.

The scanner 70 is configured to read an image of a document transported by the document feeder 20.

As shown in FIG. 2, the scanner 70 includes a first contact glass plate 71 and the second contact glass plate 72. The first contact glass plate 71 serves as a document table on which documents are placed one by one and an image of each document is read. The second contact glass plate 72 has an elongated planar structure extending in the main scanning direction, and serves as a document table on which an image of a document which is transported by the document feeder 20 is read.

The scanner 70 reads an image of a document placed on the first contact glass plate 71 as follows. Light is applied to the document from the back side of the first contact glass plate 71, and, while moving the light in the sub-scanning direction, light reflected by the document is received by a charge coupled device (CCD) image sensor (line sensor) which is linearly arranged in the main scanning direction.

The scanner 70 reads an image of a document transported by the document feeder 20 as follows. Light is applied to the document which is passing through the second contact glass plate 72 from the back side of the second contact glass plate 72, and light reflected by the document is received by a CCD image sensor.

FIG. 4 is a plan view illustrating the arrangement of document detection sensors 73a and 73b provided for the scanner 70. The document detection sensors 73a and 73b are arranged at predetermined positions in the main scanning direction and in the sub scanning direction at the back side of the first contact glass plate 71. The document detection sensors 73a and 73b output detection signals to the image reading processor 9.

The image reading processor 9 controls the driving of the document feeder 20 and the scanner 70 of the image reader 6. The image reading processor 9 also detects a document size on the basis of detection results obtained by the guide member movement sensors 61a, 61b, and 61c, the transport document detection sensors 62, 63a, 63b, and 63c, and the document detection sensors 73a and 73b and detection results obtained by a CCD image sensor 74.

The detection of a document size is not restricted to the use of the above-described sensors. Other types of sensors may be used.

The image processor 10 processes an image signal generated by reading an image of a document by the image reader 6. More specifically, the image processor 10 converts the image signal into image data (digital signal). The image processor 10 writes image data into a built-in image memory 10b and performs various types of processing, such as shading correction and offset correction, on the image data stored in the image memory 10b. In this exemplary embodiment, the image processor 10 includes a difference extracting unit 10a so as to perform difference extracting processing for extracting a difference between images of two image data. In the difference extracting processing, the image memory 10b serves as a receiving unit for receiving image data to be subjected to difference extracting processing (difference-extracting target image data). The image data obtained by the image processor 10 is stored in a storage unit, such as the HDD 4, or is output to the output processor 13.

The output processor 13 outputs image data received from the image processor 10 to the image forming unit 7 or the communication unit 14.

In this image forming apparatus 1, a difference between images read from difference-extracting target (comparison target) documents can be extracted and output. As an example of such difference extracting processing, a difference between a first image (for example, an image of an original document) and a second image (for example, an image of a document modified from the original document) may be highlighted and displayed in a new image.

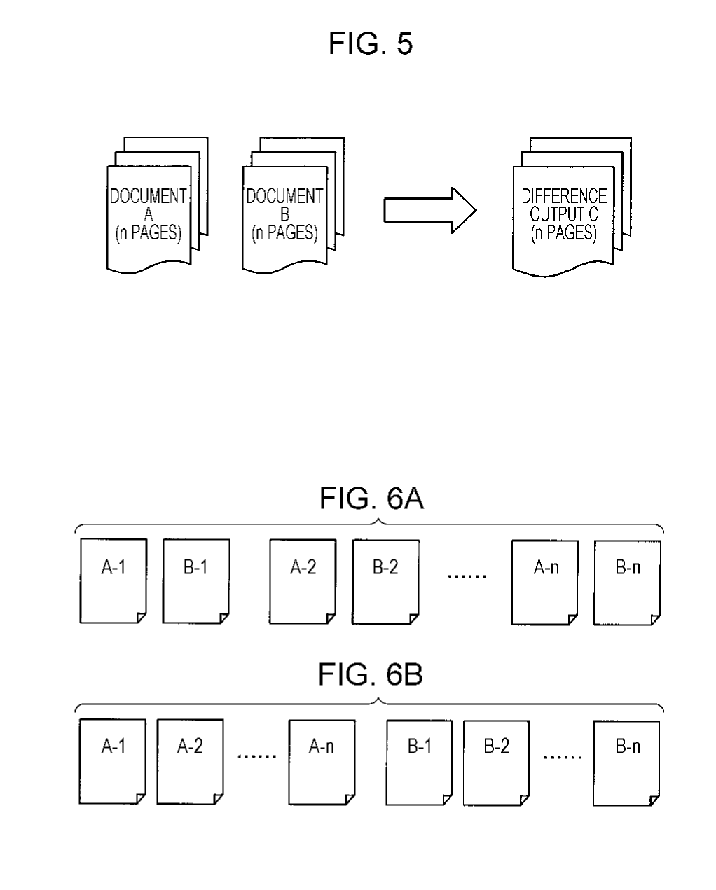

Generally, in most cases, documents, such as drawings and contracts, subjected to difference extracting processing, are managed as a set of documents or a set of files. If such documents (drawings or contracts) are subjected to difference extracting processing, as shown in FIG. 5, differences between images of plural pages of document A and images of plural pages of document B are extracted, and the plural pages of documents including the differences are output.

In such difference extracting processing on plural pages of documents, the documents are automatically and continuously fed into the image reader 6 by the document feeder 20 and are read, thereby making it possible to improve work efficiency.

In this case, the documents may be fed as documents arranged as pairs (pairs of pages) of different documents A and B (hereinafter also referred to as the “units of pairs of document pages”), or documents arranged as a set of pages of document A and a set of pages of document B (hereinafter also referred to as the “units of sets of documents”).

FIGS. 6A and 6B illustrate documents arranged as pairs (units of pairs of document pages) and documents arranged as sets of documents (units of sets of documents), respectively.

Documents arranged as pairs are, as shown in FIG. 6A, documents in which pairs of different documents, i.e., each pair formed of one page of document A and one page of document B, are continuously arranged. Documents arranged as sets of documents are, as shown in FIG. 6B, documents in which a set of pages of document A is arranged followed by a set of pages of document B.

That is, it is now assumed that a set of pages of document A having n pages {A-1, A-2, A-3, . . . , A-n} and a set of pages of document B having n pages {B-1, B-2, B-3, . . . , B-n} are subjected to difference extracting processing (difference-extracting target documents). Then, differences are extracted by comparing one page of document A and one page of document B (e.g., page A-1 and page B-1 are compared, page A-2 and page B-2 are compared, . . . , page A-n and page B-n are compared). In this case, continuously arranged pages of documents, such as A-1, B-1, A-2, B-2, . . . , A-n, B-n, are pages of documents arranged as pairs, while continuously arranged pages of documents, such as A-1, A-2, . . . , A-n, B-1, B-2, . . . , B-n, are documents arranged as sets of documents.

If such documents are single-sided page documents, the single sides of pages of the documents are comparison targets, and if such documents are double-sided page documents, the both sides of pages of the documents are comparison targets.

To extract differences in documents arranged as pairs of pages, before setting the documents in the document feeder 20, work is necessary to rearrange the documents to alternately position the pages of the different documents, and also, after reading the images of the documents, more work is necessary to divide the alternately positioned pages of the documents into the individual documents. In contrast, in the case of documents arranged as sets of documents, the documents can be directly subjected to difference extracting processing in the image forming apparatus 1 without such extra work.

In this exemplary embodiment, the image forming apparatus 1 is configured such that difference extracting processing can be implemented on documents arranged as sets of documents. The difference extracting processing of this exemplary embodiment is described in detail below.

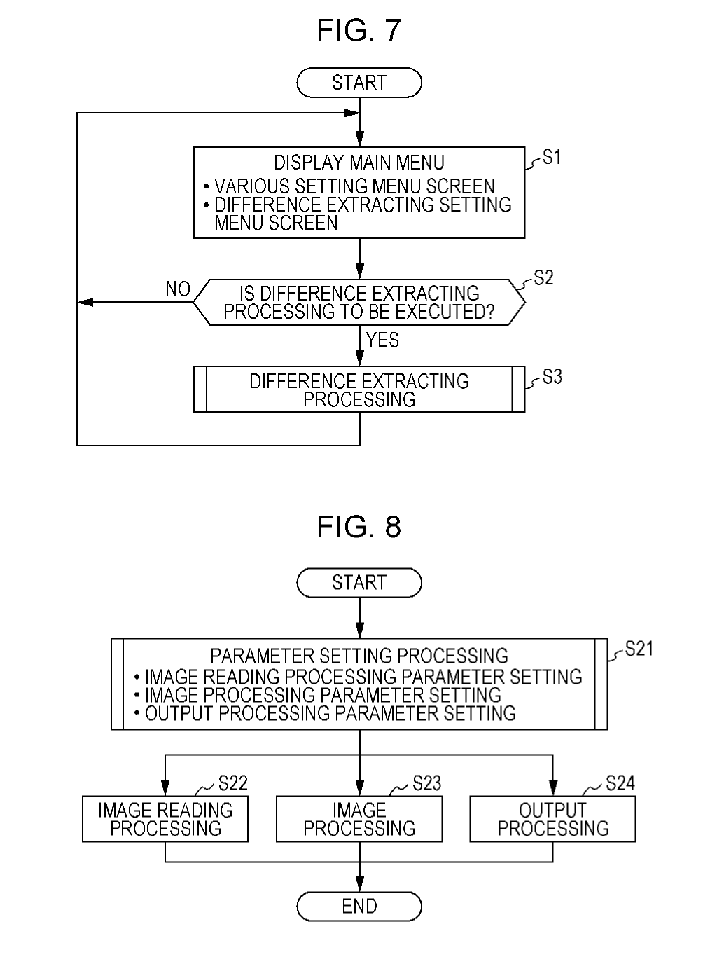

FIG. 7 is a flowchart illustrating processing for starting difference extracting processing.

In step S1, the image forming apparatus 1 displays a main menu on the display unit 5a by using the operation panel processor 11. In this case, the operation panel processor 11 switches the main menu to a difference extraction setting menu screen or another type of setting menu screen in response to an operation input by the user. This makes it possible for the user to input parameters for processing to be performed.

Then, in step S2, the image forming apparatus 1 determines by using the operation panel processor 11 (or the system controller 8) whether difference extracting processing is to be executed. More specifically, the operation panel processor 11 determines whether an operation to input an instruction to execute difference extracting processing has been performed on the menu screen. If the result of step S2 is YES, the process proceeds to step S3. If the result of step S2 is NO, the process returns to step S1.

In step S3, the image forming apparatus 1 performs difference extracting processing.

FIG. 8 is a flowchart illustrating the overall difference extracting processing.

In step S21, the parameter processor 12 performs parameter setting processing. More specifically, the parameter processor 12 calculates and sets parameters necessary for subsequent processing, i.e., image reading processing (step S22), image processing (step S23), and output processing (step S24), on the basis of information input through the operation panel 5 or system data (e.g., data stored in the ROM 2).

In the image reading processing in step S22, the image reading processor 9 controls the image reader 6 to read images of documents and outputs the read data to the image processor 10.

In the image processing in step S23, the image processor 10 performs necessary processing on the image data read in the image reading processing in step S22. Then, the image processor 10 accumulates the processed image data, and when the accumulated data reaches a predetermined number (a predetermined number of pages of read documents), the image processor 10 outputs the image data to the output processor 13.

In the output processing in step S24, the output processor 13 outputs the image data received from the image processor 10 to the image forming unit 7 or the communication unit 14. For example, the output processor 13 outputs image data of each page to the image forming unit 7, or, if the image data is to be attached to e-mail, the output processor 13 outputs all the necessary image data to the communication unit 14.

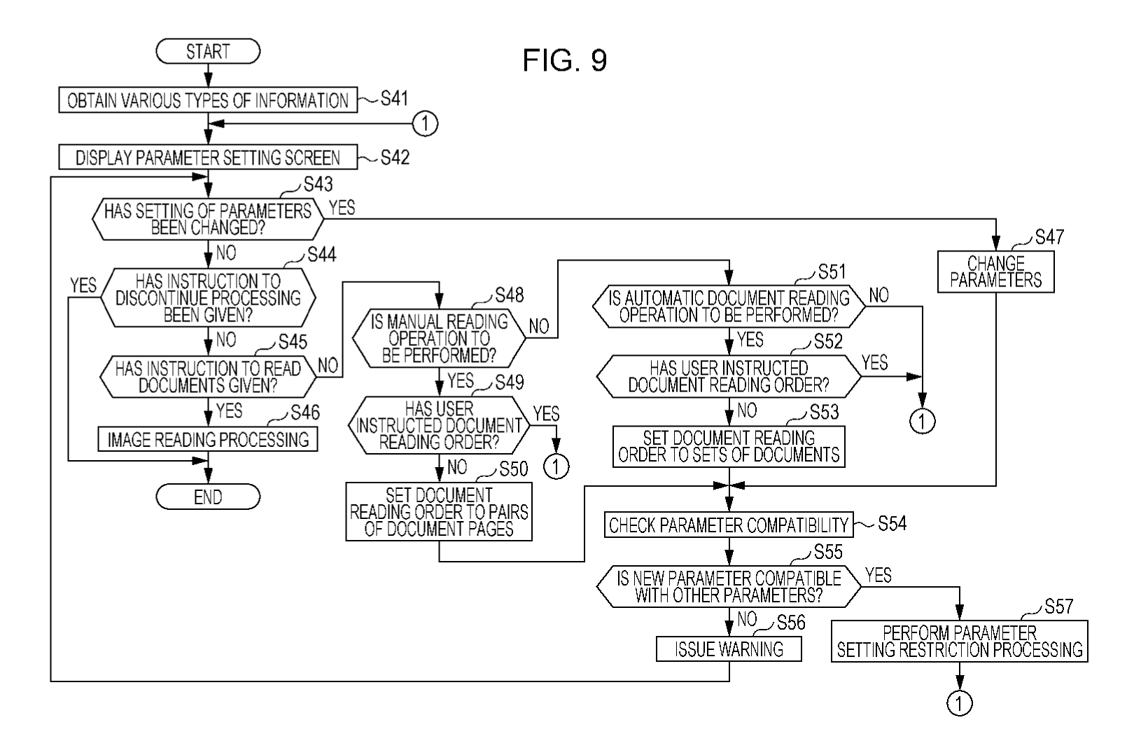

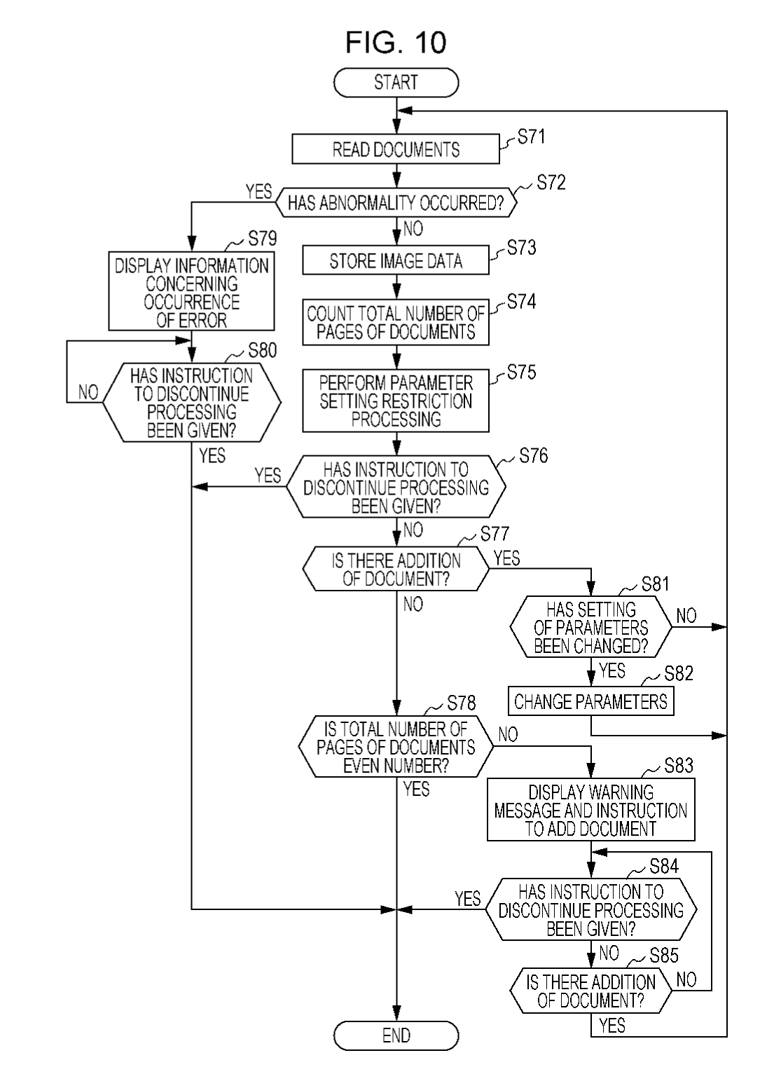

FIGS. 9 and 10 are flowcharts illustrating the parameter setting processing in step S21 and the image reading processing in step S22. FIG. 9 primarily illustrates the parameter setting processing, and FIG. 10 primarily illustrates the image reading processing.

As shown in FIG. 9, in step S41, the parameter processor 12 obtains various types of information. More specifically, the parameter processor 12 obtains information input through the operation panel 5 and system data (data stored in the memory, e.g., device capacity information). The device capacity information includes the capacity of sub-modules installed in the image forming apparatus 1.

In step S42, the parameter processor 12 (or the operation panel processor 11) displays a parameter setting screen on the display unit 5a. On the parameter setting screen, parameters necessary in the subsequent processing, i.e., the image reading processing, the image processing, and the output processing, are displayed, which makes it possible for a user to select necessary parameters.

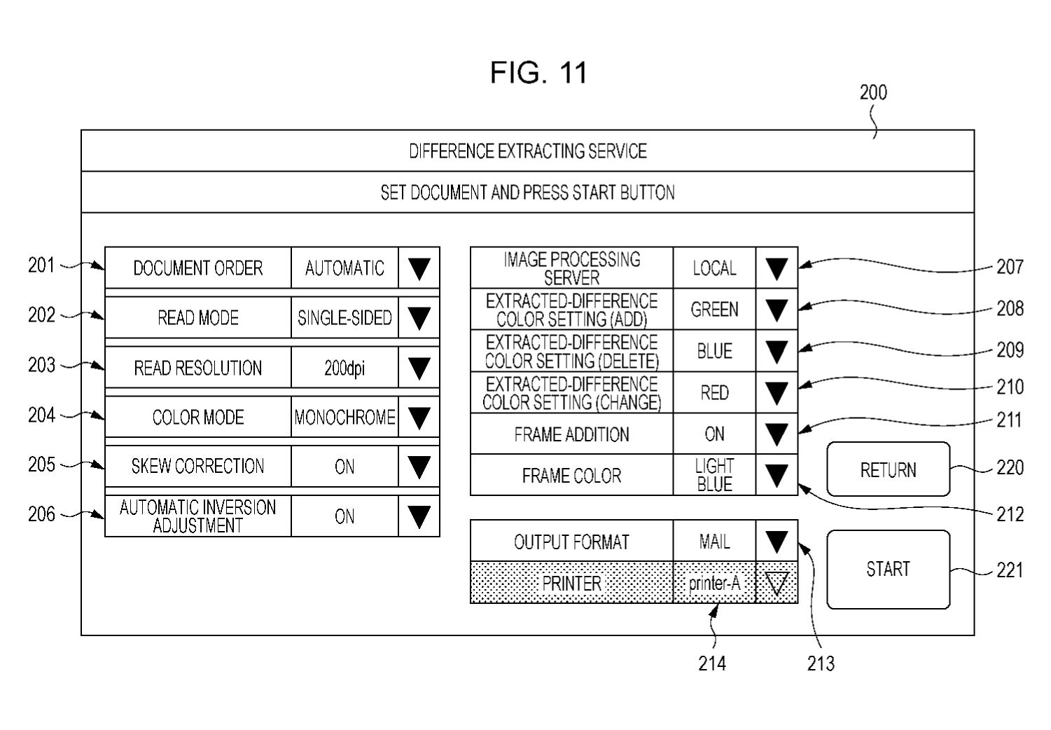

FIG. 11 illustrates an example of a parameter setting screen 200.

As shown in FIG. 11, in a “document order” field 201, the document order is selected from items “automatic”, “sets of documents”, and “pairs of document pages”. In a “read mode” field 202, the read mode is selected from items “single-sided” and “double-sided”. In a “read resolution” field 203, the read resolution is selected from items “200 dpi” and “400 dpi”. In a “color mode” field 204, the color mode is selected from items “monochrome”, “grayscale”, and “full color”. In a “skew correction” field 205, the skew correction is selected from items “ON” and “OFF”. In an “automatic inversion adjustment” field 206, the automatic inversion adjustment is selected from items “ON” and “OFF”. In an “image processing server” field 207, the image processing server is selected from items, such as “local”. In an “extracted-difference color setting (add)” field 208, the extracted-difference color is selected from items, such as “green”. In an “extracted-difference color setting (delete)” field 209, the extracted-difference color is selected from items, such as “blue”. In an “extracted-difference color setting (change)” field 210, the extracted-difference color is selected from items, such as “red”. In a “frame addition” field 211, the frame addition is selected from items “ON” and “OFF”. In a “frame color” field 212, the frame color is selected from items, such as “light blue”. In an “output format” field 213, the output format is selected from items, such as “mail”. In a “printer” field 214, the printer is selected from items, such as “printer-A”.

For example, the “sets of documents” in the “document order” field 201 is a parameter for allowing the image reader 6 to read images of documents in units of sets of documents. The “pairs of document pages” in the “document order” field 201 is a parameter for allowing the image reader 6 to read images of documents in units of pairs of document pages. The item “automatic” in the “document order” field 201 is a parameter for allowing the image forming apparatus 1 to determine whether images are to be read in units of sets of documents or in units of pairs of document pages.

The “skew correction” field 205 is a field for determining whether to perform skew correcting processing for correcting image data for skew of an image. The “automatic inversion adjustment” field 206 is a field for determining whether to adjust the leading/trailing ends of image data by automatic rotation. The “extracted-difference color setting (add)” field 208 is a field for setting the color of portions added from an original document as a result of difference extracting processing. The “extracted-difference color setting (delete)” field 209 is a field for setting the color of portions deleted from an original document as a result of difference extracting processing. The “extracted-difference color setting (change)” field 210 is a field for setting the color of portions changed from an original document as a result of difference extracting processing. The “frame addition” field 211 is a field for setting whether to surround portions representing such differences with frames. The “frame color” field 212 is a field for setting the color of frames.

The parameter processor 12 reflects the information obtained in step S41 in the display of the parameter setting screen 200.

For example, the “printer” field 214 shown in FIG. 11 is highlighted, thereby protecting the “printer” field 214 from being changed. Thus, the user is not allowed to set the parameter in the “printer” field 214.

Additionally, on the basis of the capacity of the sub-modules installed in the image forming apparatus 1, the parameter setting screen 200 is displayed as follows.

If the image forming apparatus 1 (e.g., the image processor 10) is installed with a module of a skew correcting function of correcting for skewing of images, “ON” is displayed in the “skew correction” field 205 as a default value.

If the image forming apparatus 1 is installed with a module of an automatic inversion adjustment function, “ON” is displayed in the “automatic inversion adjustment” field 206 as a default value.

The “color mode” field 204 is displayed such that it is not possible to select parameters (e.g., the number of steps expressing the density of one pixel) that cannot be processed by the image processor 10. For example, if the image processor 10 can process only binary images, the “color mode” field 204 is displayed such that the user is allowed to select only binary (“monochrome”). If the image processor 10 can process multi-level images, the “color mode” field 204 is displayed such that the user can select from binary (“monochrome”) and multi-level (“full color”).

In step S43, the parameter processor 12 determines whether the setting of the parameters has been changed. More specifically, the parameter processor 12 determines whether the user has operated a parameter setting screen, such as the parameter setting screen 200 shown in FIG. 11. If the outcome of step S43 is YES, the process proceeds to step S47. If the outcome of step S43 is NO, the process proceeds to step S44.

In step S47, the parameter processor 12 changes the parameters. Then, the process proceeds to step S54.

In step S44, the parameter processor 12 determines whether an instruction to discontinue processing has been given. More specifically, the parameter processor 12 determines whether the user has pressed a “return” button 220 (or a “cancel” button 222) on a parameter setting screen, such as the parameter setting screen 200 shown in FIG. 11. If the result of step S44 is YES, the parameter processor 12 terminates the processing shown in FIG. 9. If the result of step S44 is NO, the process proceeds to step S45.

In step S45, the parameter processor 12 determines whether an instruction to read a document has been given. More specifically, the parameter processor 12 determines whether the user has pressed a “start” button 221 on a parameter setting screen, such as the parameter setting screen 200 shown in FIG. 11. If the outcome of step S45 is YES, the process proceeds to step S46. If the outcome of step S45 is NO, the process proceeds to step S48.

In step S46, the image reader 6 performs the image reading processing (processing shown in FIG. 10).

In step S48, the parameter processor 12 determines whether a manual reading operation is to be performed. More specifically, the parameter processor 12 determines whether the document detection sensors 73a and 73b have detected the setting of a document on the first contact glass plate 71. If the result of step S48 is YES, the process proceeds to step S49. If the result of step S48 is NO, the process proceeds to step S51.

In step S49, the parameter processor 12 determines whether the user has instructed the document reading order. For example, if the “document order” field 201 on a parameter setting screen, such as the parameter setting screen 200 shown in FIG. 11, is set to be “sets of documents” or “pairs of document pages”, the parameter processor 12 determines that the user has instructed the document reading order. On the other hand, if the “document order” field 210 is set to be “automatic”, the parameter processor 12 determines that the user has not instructed the document reading order. If the outcome of step S49 is YES, the process returns to step S42. If the outcome of step S49 is NO, the process proceeds to step S50.

In step S50, the parameter processor 12 sets the parameter of the document reading order to be “pairs of document pages”. More specifically, when document reading is to be performed on a document placed on the first contact glass plate 71 and when the user has not instructed the document reading order, the parameter processor 12 sets the parameter of the document reading order to be “pairs of document pages”. Then, the process proceeds to step S54.

In step S51, the parameter processor 12 determines whether a document reading operation is to be performed by automatic feeding. More specifically, the parameter processor 12 determines whether the guide member movement sensors 61a, 61b, and 61c have detected the setting of a document on the document feeder 21. If the result of step S51 is YES, the process proceeds to step S52. If the result of step S51 is NO, the process returns to step S42.

In step S52, the parameter processor 12 determines whether the user has instructed the document reading order. If the outcome of step S52 is YES, the process returns to step S42. If the outcome of step S52 is NO, the process proceeds to step S53.

In step S53, the parameter processor 12 sets the parameter of the document reading order to the “sets of documents”. More specifically, when document reading is to be performed by using the document supply unit 21 and when the user has not instructed the document reading order, the parameter processor 12 sets the parameter of the document reading order to the “sets of documents”. The process then proceeds to step S54.

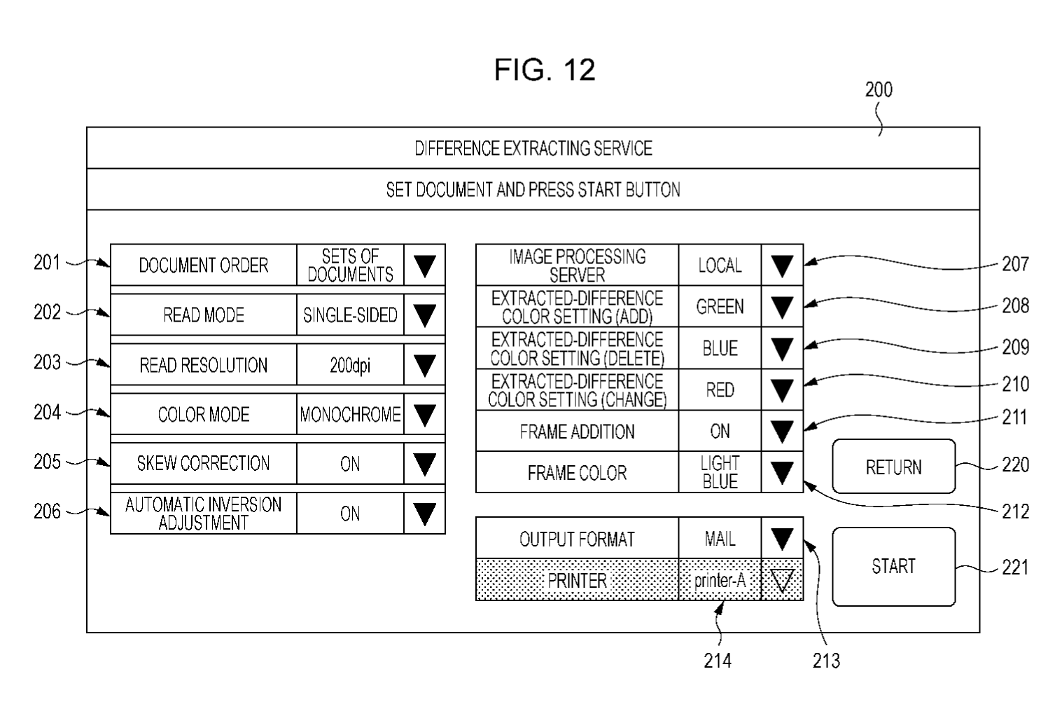

FIG. 12 illustrates an example of the parameter setting screen 200 as a result of the setting performed in step S53.

In the parameter setting screen 200, as shown in FIG. 12, the parameter of the “document order” field 201 is changed to “sets of documents”.

In step S54, the parameter processor 12 checks the parameter compatibility. More specifically, the parameter processor 12 determines whether setting (changing) of a parameter in step S47, S50, or S53 is compatible with other parameters that have already been set.

In step S55, the parameter processor 12 makes a judgment regarding the result obtained in step S54, i.e., the parameter processor 12 determines whether the setting of a parameter in step S47, S50, or S53 is compatible with the other parameters. If the outcome of step S54 is YES, the process proceeds to step S57. If the outcome of step S54 is NO, the process proceeds to step S56.

In step S56, the parameter processor 12 issues a warning indicating that the setting of a parameter is not compatible with the other parameters. For example, the parameter processor 12 controls the operation panel 5 by using the operation panel processor 11 to display a warning message on the display unit 5a. The parameter processor 11 then returns to step S43.

In step S57, the parameter processor 12 performs parameter setting restriction processing. For example, when document reading is to be performed by automatic feeding, if the parameter of the “document order” field 201 in the parameter setting screen 200 is changed to “pairs of document pages”, the parameter processor 12 sets the parameter of the “read mode” field 202 to “single-sided” and prevents the user from selecting the parameter.

The image reading processing is described below with reference to FIG. 10.

In step S71, the image reading processor 9 drives the image reader 6 to read sets of documents. This causes the image reader 6 to continuously feed documents placed on the document supply unit 21 so as to read an image of each document. Alternatively, the image reader 6 reads an image of a document placed on the first contact glass plate 71.

In step S72, the image reading processor 9 determines whether an abnormality has occurred in the documents that have been read. For example, if the size of the documents exceeds the processing capacity of the image processor 10, the image reading processor 9 determines that an abnormality has occurred so as to discontinue the image reading processing and the subsequent processing, i.e., the difference extracting processing. More specifically, if the number of pixels obtained by reading documents with the image reader 6 is equal to or greater than a predetermined threshold, the image reading processor 9 determines that an abnormality has occurred in the read documents (or that an abnormality may occur in difference extracting processing). The number of pixels is determined by the size of the read documents and the resolution (set in the parameter setting screen 200) specified when reading the documents with the image reader 6. The predetermined threshold is, for example, the number of pixels on which the image processor 10 can perform the difference extracting processing.

If the image reading processor 9 determines in step S72 that an abnormality has occurred in the read documents, the process proceeds to step S79. If the image reading processor 9 determines that no abnormality has occurred in the read documents, the process proceeds to step S73.

In step S79, the image reading processor 9 controls the operation panel 5 to display information concerning the occurrence of an error in the display unit 5a by using the operation panel controller 11.

In step S80, the image reading processor 9 determines whether the user has given an instruction to discontinue processing. The image reading processor 9 waits until the user gives an instruction to discontinue processing. When an instruction to discontinue processing is given, the image reading processor 9 discontinues the processing shown in FIG. 10.

In step S73, the image reading processor 9 stores the image data read in step S71 in a storage unit, such as the HDD 4.

In step S74, the image reading processor 9 counts the total number of pages of the documents (corresponding to the number of documents if the documents are single-sided page documents) read in step S71.

In step S75, the image reading processor 9 performs parameter setting restriction processing. More specifically, the image reading processor 9 prohibits the setting of parameters for the reading processing or the difference extracting processing that may deteriorate the difference extracting precision in the difference extracting processing.

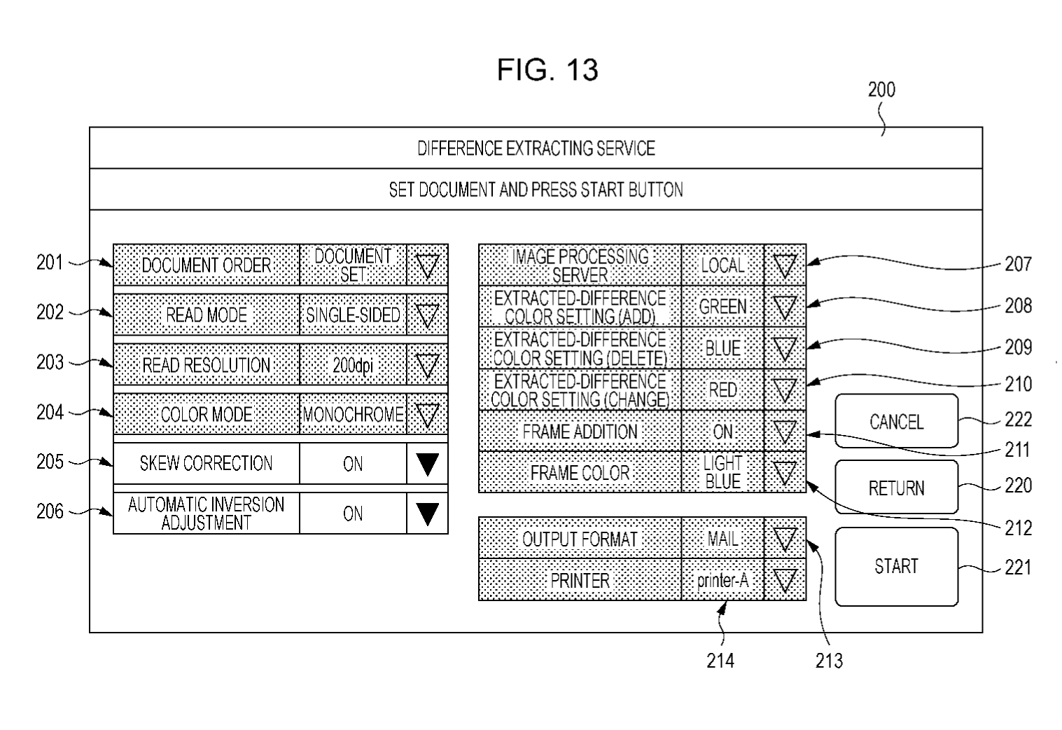

FIG. 13 illustrates an example of the parameter setting screen 200 after parameter setting restriction processing has been performed.

In the parameter setting screen 200, as shown in FIG. 13, the “document order” field 201, the “read mode” field 202, the “read resolution” field 203, the “color mode” field 204, etc. are highlighted, thereby protecting these parameters. Thus, the user is not allowed to change the parameters. That is, the parameters in those fields are maintained at the preset values.

In step S76, the image reading processor 9 determines whether an instruction to discontinue processing has given from the user. For example, the image reading processor 9 determines whether the user has operated the “cancel” button 222 on a parameter setting screen, such as the parameter setting screen 200 shown in FIG. 13. If the result of step S76 is YES, the image reading processor 9 terminates the processing shown in FIG. 10. If the result of step S76 is NO, the process proceeds to step S77.

In step S77, the image reading processor 9 determines whether there is an addition of a document to be read. For example, when the guide member movement sensors 61a, 61b, and 61c have detected the setting of a new document and when the user has input an instruction to start reading the additional document on the operation panel 5, the image reading processor 9 determines that there is an addition of a document to be read. If the outcome of step S77 is YES, the process proceeds to step S81. If the outcome of step S77 is NO, for example, if the user has input an instruction to finish reading documents on the operation panel 5, the process proceeds to step S78.

In step S81, the image reading processor 9 determines whether the user has changed the setting of parameters. If the result of step S81 is YES, the process proceeds to step S82. If the result of step S81 is NO, the process returns to step S71.

Since the parameter setting restriction processing has been performed in step S75, even if it is determined in step S81 that the setting of parameters has been changed, it has been changed within the restriction of the processing.

In step S82, the image reading processor 9 (or the parameter processor 12) changes the parameters. The process then returns to step S71.

In step S78, the image reading processor 9 determines whether the total number of pages of documents is an even number on the basis of the counting result in step S74. If the image reading processor 9 determines that the total number of pages of documents is an even number, the processing shown in FIG. 10 is completed. If the image reading processor 9 determines that the total number of pages of documents is an odd number, the process proceeds to step S83.

In step S83, the image reading processor 9 displays a warning message on the operation panel 5, and also displays an instruction to add a document. Alternatively, the image reading processor 9 may discontinue (terminate) the processing without giving those warnings.

In step S84, the image reading processor 9 determines whether the user has given an instruction to discontinue the processing. If the outcome of step S84 is YES, the processing shown in FIG. 10 is discontinued. If the outcome of step S84 is NO, the process proceeds to step S85.

In step S85, the image reading processor 9 determines whether there is an addition of documents to be read. If the result of step S85 is YES, the process returns to step S71. If the result of step S85 is NO, the process returns to step S84.

With the processing performed by the image reading processor 9, the image reader 6 reads the images of documents so as to obtain the image data. The image processor 10 then performs difference extracting processing on the basis of the obtained image data.

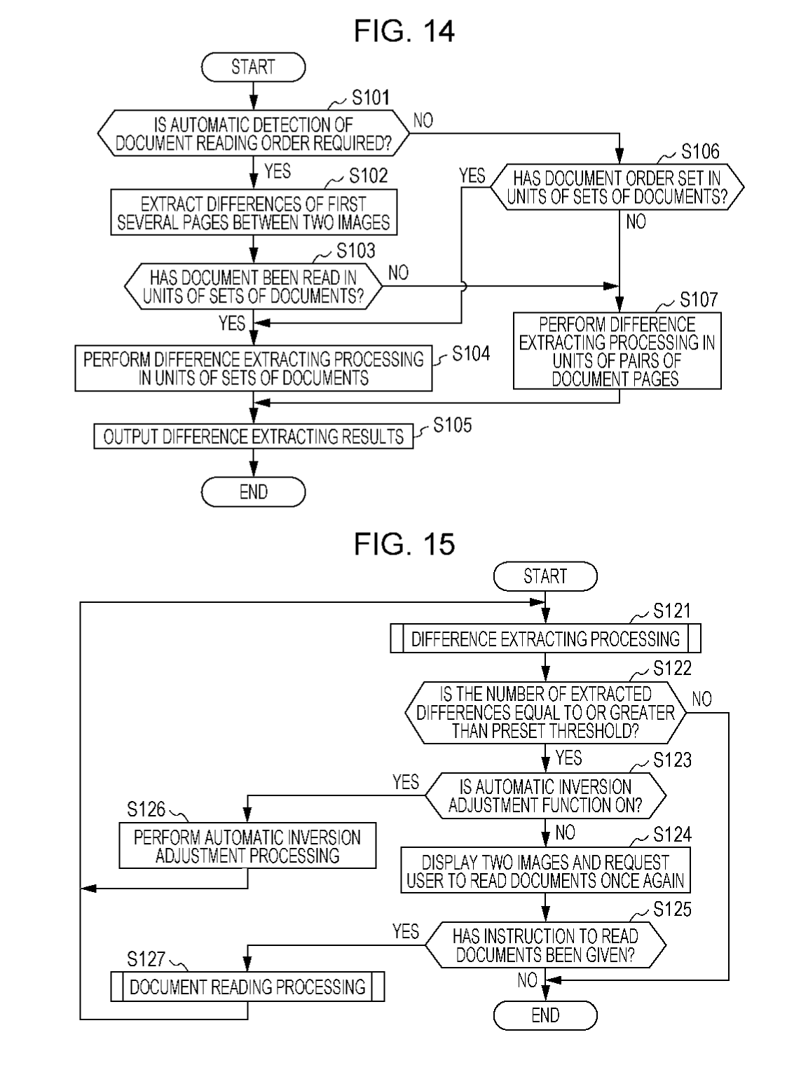

FIG. 14 is a flowchart illustrating difference extracting processing (step S23 in FIG. 8) performed by the image processor 10 (the difference extracting unit 10a).

In step S101, the image processor 10 determines whether automatic detection of the document reading order is required. More specifically, the image processor 10 determines whether the “document order” field 201 is set to be “automatic” in a parameter setting screen, such as the parameter setting screen 200 shown in FIG. 11. If the result of step S101 is YES, the process proceeds to step S102. If the result of step S101 is NO, the process proceeds to step S106.

In step S106, the image processor 10 determines on the basis of the value of the parameter whether the document reading order has been set in units of sets of documents. More specifically, the image processor 10 determines whether the “document order” field 201 is set to be “sets of documents” in a parameter setting screen, such as the parameter setting screen 200 shown in FIG. 11. Instead of setting the parameter by the user, the “document order” field 201 may have been set to be “sets of documents” in step S53 of FIG. 9.

If the image processor 10 determines in step S106 that the document reading order has been set in units of sets of documents, the process proceeds to step S104. If the image processor 10 determines in step S106 that the document reading order has not been set in units of sets of documents, i.e., if the “document order” field 201 is set to be “pairs of document pages” in a parameter setting screen, such as the parameter setting screen 200 shown in FIG. 11, the process proceeds to step S107. Instead of setting the parameter by the user, the “document order” field 201 may have been set to “pairs of document pages” in step S50 of FIG. 9.

In step S104, the image processor 10 performs difference extracting processing in units of sets of documents. For example, in the image reading processing shown in FIG. 10, numbers (page numbers) are assigned to pieces of image data in the order in which the pages of the documents have been read. On the basis of the assigned numbers, the image processor 10 extracts differences between images by comparing image data of one set of document (first set of document) with image data of the other set of document (second set of document). More specifically, for image data of documents having 2n (n=2, 3, . . . ) pages, the image processor 10 extracts differences by using the image data of the first page and the (n+1)-th page, the image data of the second page and the (n+2)-th page of the image data, the image data of the third page and the (n+3)-th page, . . . , and the image data of the n-th page and 2n-th page.

For extracting differences, various techniques are available. For example, the pixel values of two images are compared while scanning the images, and if a portion having a difference value which is equal to or greater than a preset threshold is found, such a portion is extracted as a portion having a difference. The image processor 10 then performs such difference extracting processing on all the pieces of image data. More specifically, the image processor 10 determines the difference values between the pixel values of the pixels forming the image of the first page and the pixel values of the pixels, which are located at positions corresponding to the positions of the pixels of the image of the first page, forming the image of the (n+1)-th page. If a portion having a difference value which is equal to or greater than the threshold is found, the image processor 10 specifies such a portion as a portion having a difference. The image processor 10 performs processing for finding difference values (processing for specifying a portion having a difference) on all the pixels forming the images. Then, the image processor 10 determines the sum of the specified portions having differences, and sets the sum as the number of differences.

On the other hand, in step S107, the image processor 10 performs difference extracting processing in units of pairs of document pages. For example, the image processor 10 extracts differences between images by comparing two pieces of image data (one piece of image data of an odd-numbered page and another piece of image data of an even-numbered page) obtained in the document reading order. More specifically, for image data having 2n (n=2, 3, . . . ) document pages, the image processor 10 extracts differences by comparing the image data of the first page and the other image data of the second page, the image data of the third page and the other image data of the fourth page, the image data of the fifth page and the other image data of the sixth page, . . . , the image data of the (2n−1)-th page and the other image data of the 2n-th page. Then, the process proceeds to step S105.

In step S105, the image processor 10 outputs difference extracting results obtained by the difference extracting processing. More specifically, on the basis of one of the two pieces of difference extracting target image data, the image processor 10 generates image data by highlighting portions having differences by using a frame or a preset color. In this case, the image processor 10 highlights the portion having differences on the basis of the “extracted-difference color setting (add)” field 208, the “extracted-difference color setting (deletion)” field 209, the “extracted-difference color setting (change)” field 210, and the “frame addition” field 211, which are set in the parameter setting screen 200. The image processor 10 then outputs the generated image data to the output processor 13.

The output processor 13 then outputs the image data to the image forming unit 7 or attaches the image data to e-mail on the basis of the “output format” field 213 and the “printer” field 214 set in the parameter setting screen 200 (step S24 of FIG. 8).

If it is determined in step S101 that automatic detection of document reading order is required, in step S102, the image processor 10 performs difference extracting processing on the first several pages (a preset number of pages) of the two continuous images.

In step S103, the image processor 10 determines on the basis of the difference extracting results obtained in step S102 whether the images of the documents have been read in the units of sets of documents. More specifically, if the number of differences obtained in the difference extracting processing in step S102 is greater than a preset threshold, the image processor 10 determines that the image of the documents have been read in units of sets of documents. If the number of differences is equal to or smaller than the preset threshold, the image processor 10 determines that the images of the documents have been read in units of pairs of document pages. If it is determined in step S103 that the images of the documents have been read in units of sets of documents, the process proceeds to step S104. If it is determined in step S103 that the images of the documents have been read in units of pairs of document pages, the process proceeds to step S107.

The image processor 10 is also provided with an automatic inversion adjustment function.

FIG. 15 is a flowchart illustrating automatic inversion adjustment processing performed by the image processor 10.

In step S121, the image processor 10 performs difference extracting processing. The difference extracting processing in step S121 is that such as the processing shown in FIG. 14.

Then, in step S122, the image processor 10 determines whether the number of differences (the number of portions having differences) extracted in the difference extracting processing performed on all the pieces of image data is equal to or greater than a preset threshold. If the outcome of step S122 is YES, the process proceeds to step S123. If the outcome of step S122 is NO, the image processor 10 completes the processing shown in FIG. 15. That is, the image processor 10 utilizes the current difference extracting results without performing inversion adjustment processing.

In step S123, the image processor 10 determines whether the automatic inversion adjustment function is ON. More specifically, the image processor 10 determines whether the “automatic inversion adjustment” field 206 in a parameter setting screen, such as the parameter setting screen 200 shown in FIG. 11, is set to be ON. If the result of step S123 is YES, the process proceeds to step S126. If the result of step S123 is NO, the process proceeds to step S124.

In step S126, the image processor 10 performs automatic inversion adjustment processing for adjusting the leading/trailing ends of the image data by automatic rotation processing. For example, if the difference extracting results are obtained by performing difference extracting processing in units of sets of documents, the image processor 10 performs automatic rotation processing on the first half of the image data or the second half of the image data. If the difference extracting results are obtained by performing difference extracting processing in units of pairs of document pages, the image processor 10 performs automatic rotation processing on the image data of the odd-numbered pages or the image data of the even-numbered pages. Then, the process returns to step S121.

In step S124, the image processor 10 displays the two difference extracting target images and requests the user to read the documents once again. Alternatively, the image processor 10 may discontinue (terminate) the processing without displaying images or requesting the user.

In step S125, the image processor 10 determines whether an instruction to read documents has been given. If the outcome of step S125 is YES, the process proceeds to step S127. If the outcome of step S125 is NO, for example, if the user has given an instruction to discontinue the processing, the image processor 10 discontinues the processing shown in FIG. 15.

Alternatively, if it is determined in step S123 that the automatic inversion adjustment function is OFF, the image processor 10 may terminate the processing shown in FIG. 15 without executing steps S124 and S125. That is, if the automatic inversion adjustment function is set to be OFF, the image processor 10 completes the processing. Also, if it is determined in step S122 that the number of extracted differences is smaller than the threshold (particularly, when the image processor 10 is not provided with the automatic inversion adjustment function), the image processor 10 may terminate the processing.

In step S127, the image processor 10 (image reading processor 9) performs document reading processing, such as that indicated by the flowcharts of FIGS. 9 and 10. Upon completion of the document reading processing, the image processor 10 restarts the processing from step S121.

The image forming apparatus 1 configured as described above is operated in the difference extracting processing as follows.

If the user has operated the parameter setting screen 200 before an instruction to read documents is given, or if a manual document reading operation is to be performed, or if a document reading operation is to be performed by automatic feeding, the image forming apparatus 1 changes the parameters (step S43 and steps S48 through S55). Then, the image forming apparatus 1 checks the parameter compatibility between the changed parameters and other parameters, and gives a warning or performs parameter setting restriction processing in accordance with the result of checking the parameter compatibility (steps S54 through S57). Then, in response to an instruction to read documents from the user, the image forming apparatus 1 starts image reading processing (steps S45 and S46).

In the image reading processing, the image forming apparatus 1 performs processing on the basis of the preset parameters. In this case, the image forming apparatus 1 continuously feeds documents placed on the document feeding unit 21 into the image reader 6 so as to read an image of each document. Alternatively, the image reader 6 reads an image of a document placed on the first contact glass plate 71. If double-sided page documents are set on the document supply unit 21, images on both sides of the documents are read by using the mechanism shown in FIG. 2. Upon completion of reading of the images of the documents, the image forming apparatus 1 stores the image data obtained by the image reader 6 in a storage unit, such as the HDD 4 (steps S71 through S74).

If there is an addition of a document to be read, the image forming apparatus 1 performs the image reading processing once again by performing the parameter setting restriction processing and by reflecting parameters changed by the user (within the restriction allowed in the parameter setting restriction processing) (steps S71, S75 through S77, S81, and S82).

If an instruction to discontinue image reading has been given from the user, and, in this case, if the total number of pages of the documents that have been read is an even number, the image forming apparatus 1 completes the processing (steps S77 and S78). On the other hand, if the total number of pages of the documents that have been read is an odd number, the image forming apparatus 1 displays a warning message on the operation panel 5 and displays an instruction to add a document. If an instruction to discontinue the processing has been given from the user, the image forming apparatus 1 discontinues the processing. If there is an addition of a document, the image forming apparatus 1 performs the image reading operation once again (steps S78, S83 through S85).

Then, the image forming apparatus 1 performs difference extracting processing on the image data obtained by the image reading processing in units of sets of documents or in units of pairs of document pages. If automatic detection of the document reading order is required, the image forming apparatus 1 performs difference extracting processing on the image data of the first several pages, and determines whether the document reading operation has been performed in units of sets of documents. If the document reading operation has been performed in units of sets of documents, the image forming apparatus 1 performs difference extracting processing in units of sets of documents. If the document reading operation has been performed in units of pairs of document pages, the image forming apparatus 1 performs difference extracting processing in units of pairs of document pages. The image forming apparatus 1 then outputs the difference extracting results to the image forming unit 7 or the display unit 5a (steps S101 through S105, and S107).

If the document reading order has not been automatically set, the image forming apparatus 1 performs difference extracting processing in units of sets of documents or in units of pairs of document pages on the basis of the parameter values, and outputs the difference extracting results to the image forming unit 7 or the display unit 5a (steps S101, S104 through S107).

Information for specifying portions having extracted differences is added to the image output to the image forming unit 7. That is, in one of the difference extracting target images, portions added to and deleted from as a result of difference extracting processing are highlighted in different colors.

In this exemplary embodiment, as first and second image readers, the image reader 6, for example, is used. As first and second difference extracting units, the difference extracting unit 10a, for example, is used. That is, for example, a receiving unit and the first and second difference extracting units are implemented by reading the program 2a from the ROM 2 into the RAM 3 by the CPU 8a and by causing the image processor 10 (or the difference extracting unit 10a) to perform processing. As first and second restriction units, the image reading processor 9 (particularly, the processing function in step S75), for example, is used. As a permission unit, the parameter processor 12 (particularly, the processing function in step S53), for example, is used. As a discontinuation unit and a first instruction unit, the image reading processor 9 (particularly, the processing functions in steps S78 and S83), for example, is used. As a processing unit and a fourth restriction unit, the parameter processor 12 (particularly, the processing function in step S42), for example, is used. As a second correction unit, the image processor 10 (particularly, the skew correction function), for example, is used. As a re-executing unit and a second instruction unit, the image processor 10 (particularly, the automatic inversion adjustment function of the processing shown in FIG. 15), for example, is used.

Examples of modifications made to this exemplary embodiment are as follows.

In the processing for outputting difference extracting results in step S105, instead of outputting difference extracting results to an external source, they may be stored in a storage unit, such as the HDD 4. In this case, the user can extract the difference extracting results stored in the storage unit when necessary.

In this exemplary embodiment, the image reader 6 and the image processor 10 that performs difference extracting processing are disposed in the same image forming apparatus 1. However, the invention is not restricted to such a configuration. For example, the image reader 6 and the image processor 10 may be disposed in different image forming apparatuses, or they may be formed as independent apparatuses.

In this case, image data read by an information processing apparatus provided with the image reader 6 may be sent to a server provided with the image processor 9 (image processing apparatus), and difference extracting processing may be performed in the server.

In this case, the server returns information for specifying differences extracted in difference extracting processing, a difference image (image reflecting the differences), or a document image, if necessary, to the information processing apparatus. In this case, upon receiving the information for specifying the differences and the difference image, the information processing apparatus may reflect the information for specifying the differences in the document image, and may output the reflected image to the display unit. The reflected image may be printed. Additionally, although the information processing apparatus adds the information for specifying the differences to a document, the invention is not restricted to this configuration. For example, the server may add such information to a document.

The information for specifying differences and a difference image are returned to the information processing apparatus that has read documents. However, the invention is not restricted to this configuration. The information for specifying differences, a document image, or an image reflecting the information for specifying the differences may be transferred to another information processing apparatus that has not read the documents. In this case, the server requires information concerning the information processing apparatus to which the above-described information is transferred. Accordingly, it is necessary that the image reader 6 set in advance the information concerning the information processing apparatus to which information is transferred in order to send the information to the server. This makes it possible for the server to transfer, on the basis of this information, the information for specifying differences or a document image to the information processing apparatus.

Also, if the size of documents exceeds the processing capacity of the image processor 10, instead of discontinuing the processing (steps S79 and S80), information for instructing to change the range in which the documents are read or to change the resolution may be given. Further, the images of documents may be corrected or processed so as to allow the image processor 10 to process the images of the documents. For example, the resolution of image data may be converted, for example, reduced, or the image data may be divided, for example, into four portions if the number of pixels of the image data is too large to extract differences. Then, the resulting image data may be output to the image processor 10. For example, if image data is divided, the image processor 10 may extract differences for each divided portion of the image data and then recombines the divided portions. Recombining divided portions includes calculating the sum of the difference values obtained for the individual divided portions and physically connecting the divided portions of the image data.

Additionally, the image processor 10 may perform difference extracting processing both in units of sets of documents and in units of pairs of document pages for all pieces of image data. Then, the image processor 10 may take a smaller number of differences as the difference extracting results and outputs the results to the output processor 13. This type of processing may be performed when automatic detection of the document reading order is required.

In the image forming apparatus 1, the user may determine whether a document reading operation is performed by manually or by automatic feeding by operating the parameter setting screen 200. In this case, when a manual document reading operation is set, the image forming apparatus 1 sets the document reading order to be “pairs of document pages”, and when an automatic-feeding document reading operation is set, the image forming apparatus 1 sets the document reading order to be “sets of documents”.

The image forming apparatus 1 may preset an operation in case of any difficulty in continuing processing.

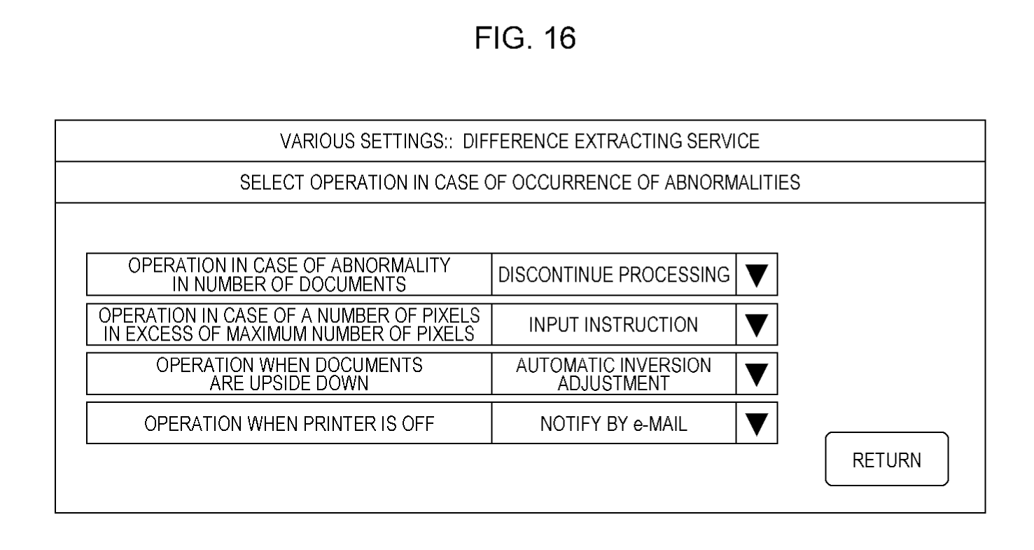

FIG. 16 illustrates an example of a menu screen that allows a user to preset such an operation.

As shown in FIG. 16, in a field “operation in case of an abnormality in the number of documents”, the operation is selected from items, such as “discontinue processing” and “display warning message”. This can prevent the image forming apparatus 1 from extracting differences between documents having different pages (two different documents cannot be compared), or enables the image forming apparatus 1 to issue a warning on this matter.

With this setting, if the image forming apparatus 1 determines in step S78 that the total number of document pages is an odd number, it discontinues the processing or displays a warning message in accordance with the item selected from the field “operation in case of an abnormality in the number of document pages”.

A second setting unit may be provided to perform the above-described processing.

In a field “operation in case of a number of pixels in excess of the maximum number of pixels”, the operation is selected from items, such as “input instruction”, “discontinue processing”, and “display warning message”. With this setting, if the number of pixels (or the size) of documents read by the image reader 6 exceeds the processing capacity of the image processor 10, the image forming apparatus 1 may be operated in accordance with the setting of the field “operation in case of a number of pixels in excess of the maximum number of pixels”.

In a field “operation when document pages are upside down”, the operation is selected from items, such as “automatic inversion adjustment”, “discontinue processing”, and “display warning message”. Accordingly, the automatic inversion adjustment processing shown in FIG. 15 may be performed or the processing may be discontinued in accordance with the item selected from the field “operation when documents are upside down”.

A fifth setting unit may be provided to discontinue automatic inversion adjustment processing.

In a field “operation when printer is OFF”, the operation is selected from items, such as “notify by e-mail”.

The receiving unit may be formed as a communication interface (I/F) controller. In this case, the communication I/F controller receives image data from another apparatus via a communication medium, such as a LAN, the Internet, or a public switched network. Alternatively, the communication I/F controller may receive image data from the image reader 6.

If a program is used, it may be provided via a communication medium, such as a LAN, the Internet, or a public switched network, or may be provided by being stored in a recording medium, such as a CD-ROM. That is, instead of recording predetermined programs including an image processing program on a storage device, such as a hard disk, the predetermined programs may be provided as follows.

For example, the predetermined programs may be stored in a ROM, and a CPU may load the predetermined programs into a main storage device, and may execute them.

Alternatively, the predetermined programs may be stored in a computer readable recording medium, such as a digital versatile disk (DVD)-ROM, a CD-ROM, a magneto-optical (MO) disk, or a flexible disk, and may be distributed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a receiving unit that receives images of a document; and
a first difference extracting unit that performs difference extracting processing for extracting a difference between images of a document having 2n (n=2, 3, . . . ) pages received by the receiving unit by comparing the image of the first page and the image of the (n+1)-th page, the image of the second page and the image of the (n+2)-th page, the image of the third page and the image of the (n+3)-th page, . . . , and the image of the n-th page and the image of the 2n-th page.

2. The image processing apparatus according to claim 1, further comprising an output unit that outputs an image to which information for specifying a portion having a difference extracted by the first difference extracting unit is added, the image being output by being formed or being displayed.

3. The image processing apparatus according to claim 2, wherein:
the image to which the information for specifying a portion having a difference is added is one of a pair of images, which serve as difference extracting target images, subjected to the difference extracting processing by the first difference extracting unit;
the information for specifying a portion having a difference is indicated for a portion added to and a portion deleted from the one of the pair of images; and
the portion added and the portion deleted are indicated in different colors.

4. An image processing system comprising:
a first image reader that sequentially and continuously reads a plurality of documents;
a second image reader that reads a document placed on a document table;
a first difference extracting unit that performs difference extracting processing for extracting a difference between images of a document having 2n (n=2, 3, . . . ) pages by comparing the image of the first page and the image of the (n+1)-th page, the image of the second page and the image of the (n+2)-th page, the image of the third page and the image of the (n+3)-th page, . . . , and the image of the n-th page and the image of the 2n-th page;
a second difference extracting unit that performs difference extracting processing for extracting a difference between images of a document having 2n (n=2, 3, . . . ) pages by comparing the image of the first page and the image of the second page, the image of the third page and the image of the fourth page, the image of the fifth page and the image of the sixth page, . . . , and the image of the (2n−1)-th page and the image of the 2n-th page; and
a first setting unit that performs setting such that the first difference extracting unit extracts a difference between the images of the document read by the first image reader when selecting the first image reader to read the document, and that performs setting such that the second difference extracting unit extracts a difference between the images of the document read by the second image reader when selecting the second image reader to read the document.

5. The image processing system according to claim 4, further comprising a first output unit that outputs an image to which information for specifying a portion having a difference extracted by the first difference extracting unit or the second difference extracting unit is added, the image being output by being formed or being displayed.

6. The image processing system according to claim 5, wherein:
the image to which the information for specifying a portion having a difference is added is one of a pair of images, which serve as difference extracting target images, subjected to the difference extracting processing by the first difference extracting unit or the second difference extracting unit;
the information for specifying a portion having a difference is indicated for a portion added to and a portion deleted from the one of the pair of images; and
the portion added and the portion deleted are indicated in different colors.

7. The image processing system according to claim 4, further comprising a first restriction unit that restricts changing of settings, which have been set in advance, necessary for reading the document with the first image reader or the second image reader until the first difference extracting unit or the second difference extracting unit finishes extracting a difference.

8. The image processing system according to claim 4, further comprising a second restriction unit that restricts changing of the settings set by the first setting unit until the first difference extracting unit or the second difference extracting unit finishes extracting a difference.

9. The image processing system according to claim 4, wherein;
the first image reader is capable of reading both sides of a document; and
the image processing system further comprises a permission unit that permits the first image reader to read the document on condition that single sides of the document are to be read when the first setting unit performs setting such that the second difference extracting unit extracts a difference between the images of the document read by the first image reader when selecting the first image reader to read the document.

10. The image processing system according to claim 4, further comprising a discontinuation unit that counts the number of pages of a document read by the first image reader or the second image reader and that discontinues the difference extracting processing performed on images of the document by the first difference extracting unit or the second difference extracting unit when the counted number of the pages of the document is an odd number.

11. The image processing system according to claim 4, further comprising a first instruction unit that counts the number of pages of a document read by the first image reader or the second image reader and that provides information for giving an instruction to read an additional document by using the first image reader or the second image reader when the counted number of the pages of the document is an odd number.

12. The image processing system according to claim 4, further comprising a processor that performs processing for discontinuing reading an image of a document read by the first image reader or the second image reader or for providing information for giving an instruction to change a range of the document to be read or to change the resolution specified when reading the document with the first image reader or the second image reader when the number of pixels of the image of the document read by the first image reader or the second image reader is equal to or greater than a preset threshold, the number of pixels being determined by the size and the resolution of the document.

13. The image processing system according to claim 4, further comprising a first correction unit that makes a correction to reduce the number of pixels of an image of a document read by the first image reader or the second image reader when the number of pixels of the image of the document read by the first image reader or the second image reader is equal to or greater than a preset threshold, the number of pixels being determined by the size of the document and the resolution specified when reading the document with the first image reader or the second image reader.

14. The image processing system according to claim 4, further comprising a dividing unit that divides an image of a document read by the first image reader or the second image reader when the number of pixels of the image of the document read by the first image reader or the second image reader is equal to or greater than a preset threshold, the number of pixels being determined by the size of the document and the resolution specified when reading the document with the first image reader or the second image reader,
wherein the first difference extracting unit or the second difference extracting unit extracts a difference by using image portions obtained as a result of dividing the image with the dividing unit.

15. The image processing system according to claim 4, further comprising a fourth restriction unit that restricts, when selecting the number of steps expressing the density of one pixel of an image of a document read by the first image reader or the second image reader, a selection of the number of steps that is not to be processed by the first difference extracting unit or the second difference extracting unit.

16. The image processing system according to claim 4, further comprising a second correction unit that corrects skew of an image of a document read by the first image reader or the second image reader unless correction of skew is restricted.

17. The image processing system according to claim 4, further comprising a re-executing unit that changes, when the number of portions having differences between a pair of images subjected to difference extracting processing performed by the first difference extracting unit or the second difference extracting unit exceeds a preset number, orientations of leading/trailing ends of one of the pair of images and re-executes the difference extracting processing once again.

18. The image processing system according to claim 4, further comprising a second instruction unit that provides information for giving an instruction to read a document once again by using the first image reader or the second image reader when the number of portions having differences between a pair of images subjected to difference extracting processing performed by the first difference extracting unit or the second difference extracting unit exceeds a preset number.

19. The image processing system according to claim 4, further comprising a fifth restriction unit that restricts difference extracting processing performed by the first difference extracting unit or the second difference extracting unit when the number of portions having differences between a pair of images subjected to the difference extracting processing performed by the first difference extracting unit or the second difference extracting unit exceeds a preset number.

20. The image processing system according to claim 4, further comprising a second output unit that outputs, as a result of extracting differences between images of a document read by the first image reader or the second image reader, between the number of portions having differences between a pair of images subjected to difference extracting processing performed by the first difference extracting unit and the number of portions having differences between a pair of images subjected to difference extracting processing performed by the second difference extracting unit, a smaller number of portions having differences as difference extracting results.

21. A computer readable medium storing a program causing a computer to execute a process, the process comprising:
receiving images of a document; and
performing difference extracting processing for extracting a difference between images of a document having 2n (n=2, 3, . . . ) pages by comparing the image of the first page and the image of the (n+1)-th page, the image of the second page and the image of the (n+2)-th page, the image of the third page and the image of the (n+3)-th page, . . . , and the image of the n-th page and the image of the 2n-th page.
